(19) United States
(12) Patent Application Publication
(10) Pub. No.: US 2026/0363183 A1
(43) Pub. Date: Nov. 19, 2026

(54) REEL CONTROL FOR CROP INPUT APPLICATION VEHICLE

(71) Applicant: MA Industries, LLC, Morton, IL (US)

(72) Inventors: Gregg A. Sauder, Morton, IL (US); Timothy Sauder, Morton, IL (US); Justin Koch, Morton, IL (US); Nowell Moore, Morton, IL (US); Reid J. Aberle, Morton, IL (US); Tyler Nafziger, Morton, IL (US); Connor Hesterberg, Morton, IL (US); Jonathan T. Welte, Morton, IL (US); Kyle Waremburg, Morton, IL (US); Steven Nuest, Morton, IL (US); Talon Sauder, Morton, IL (US); Phillip Baurer, Morton, IL (US)

(21) Appl. No.: 19/155,377

(22) PCT Filed: Feb. 9, 2024
(86) PCT No.: PCT/US2024/015248

§ 371 Date: Aug. 11, 2025

Related U.S. Application Data
(60) Provisional application No. 63/484,124, filed on Feb. 9, 2023.

(51) Int. Cl. A01G 25/09; A01G 25/16

(52) U.S. Cl. CPC A01G 25/095; A01G 25/16

(57) ABSTRACT

A crop application input vehicle includes a reel having a conduit positioned thereon. A motor drives rotation of the reel. Control of the reel can be adjusted based on output from one or more sensors.

### BACKGROUND

This disclosure relates to application of crop input and use of vehicles for application of crop input. The vehicle supports a reel and flexible conduit that can be extended from or retracted onto said reel.

### BRIEF DESCRIPTION OF THE DRAWINGS

FIG. 1 is a front perspective view of a crop input application vehicle.

FIG. 2 is a rear perspective view of the application vehicle of FIG. 1.

FIG. 3 is a right-side view of the application vehicle of FIG. 1.

FIG. 4 is a left-side view of the application vehicle of FIG. 1.

FIG. 5 is a front view of the application vehicle of FIG. 1.

FIG. 6 is a rear view of the application vehicle of FIG. 1 with a boom removed.

FIG. 7 is a top view of the application vehicle of FIG. 1 with a boom removed.

FIG. 8 is a bottom view of the application vehicle of FIG. 1 with a boom removed.

FIG. 9 is a front perspective view of a conduit dispensing assembly.

FIG. 10 is a rear perspective view of the conduit dispensing assembly of FIG. 9.

FIG. 11 is a right-side view of the conduit dispensing assembly of FIG. 9.

FIG. 12 is a left-side view of the conduit dispensing assembly of FIG. 9.

FIG. 13 is a top view of the conduit dispensing assembly of FIG. 9.

FIG. 14 is a schematic diagram of a control system used to control the vehicle of FIG. 1.

FIG. 15 is a close-up side view of a reel mounted to the vehicle of FIG. 1.

FIG. 16 is a close-up perspective view of the reel of FIG. 15.

### DESCRIPTION

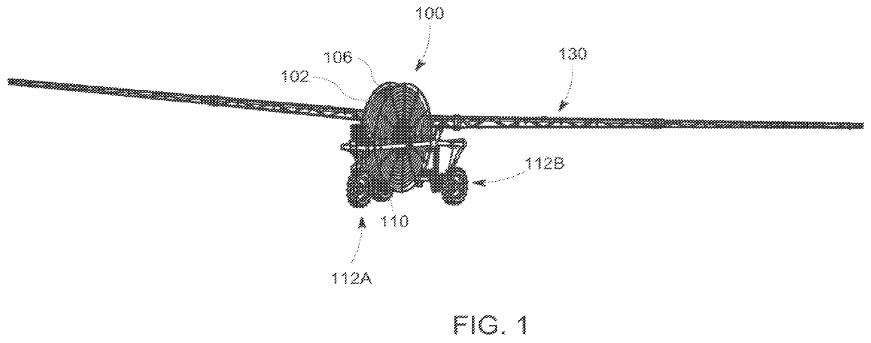

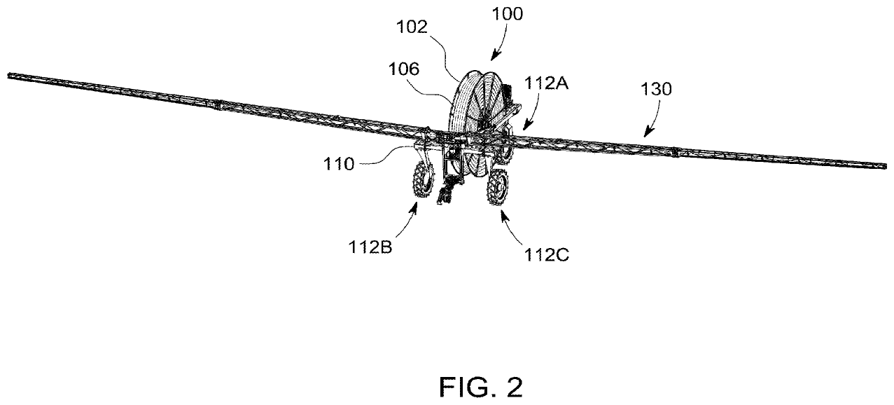

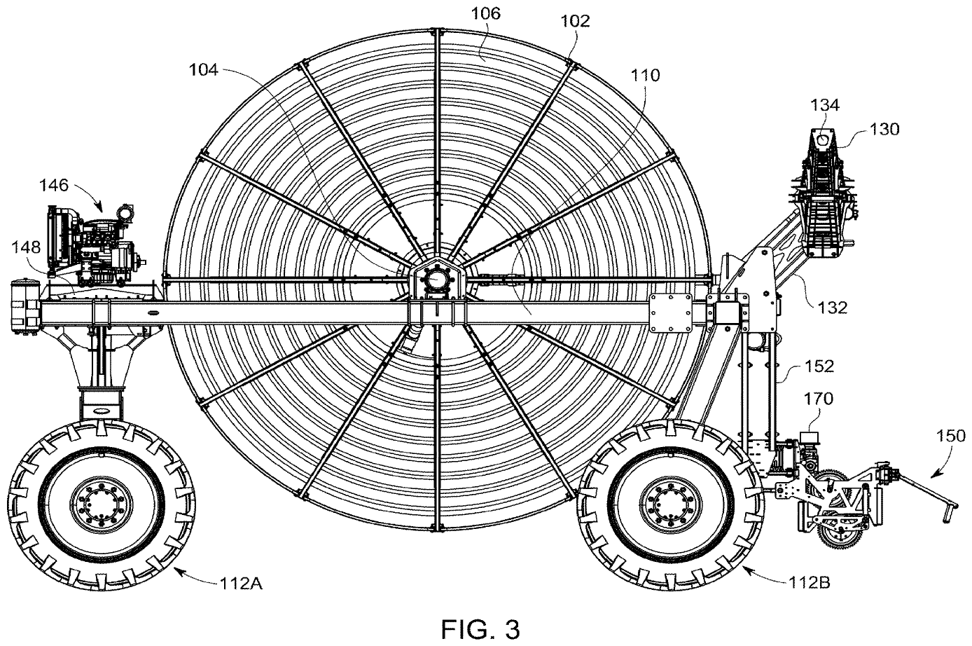

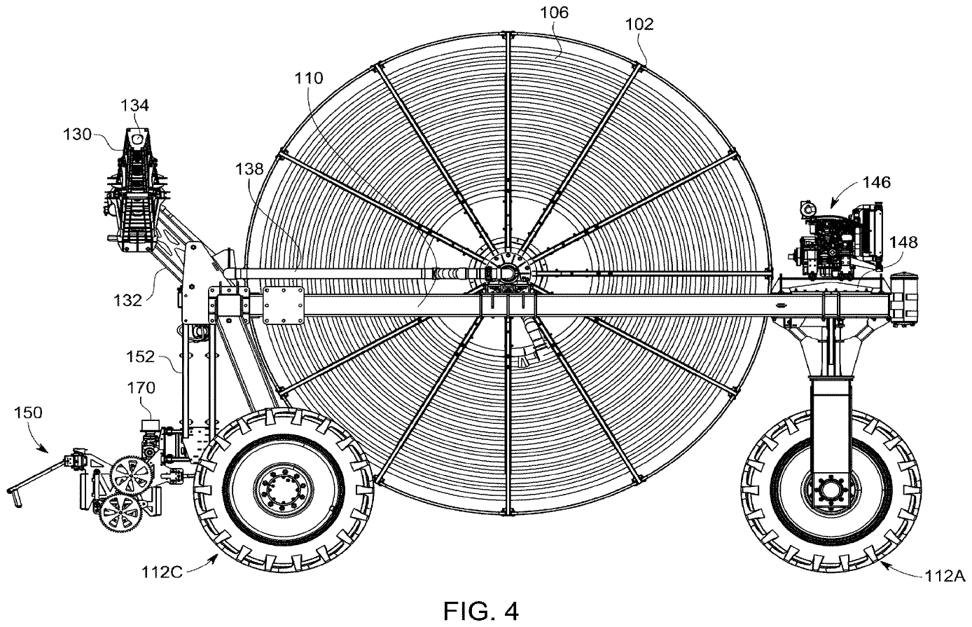

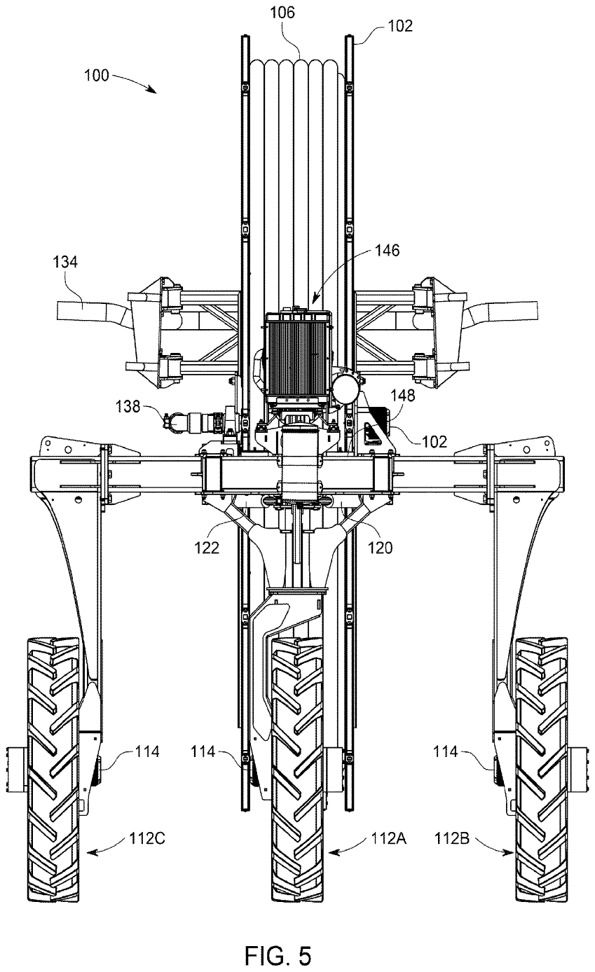

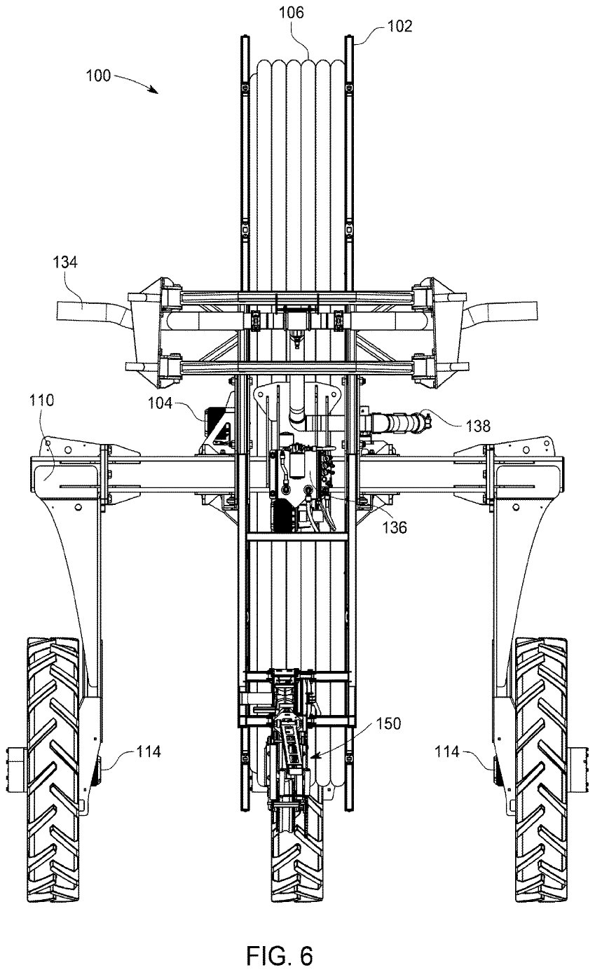

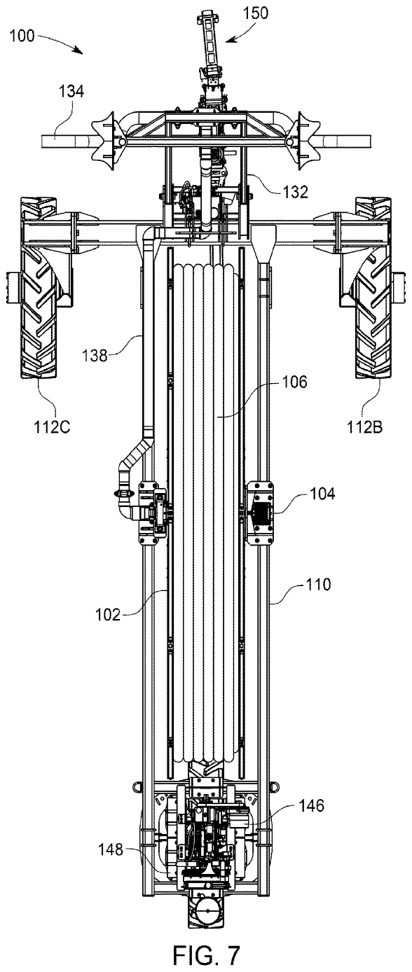

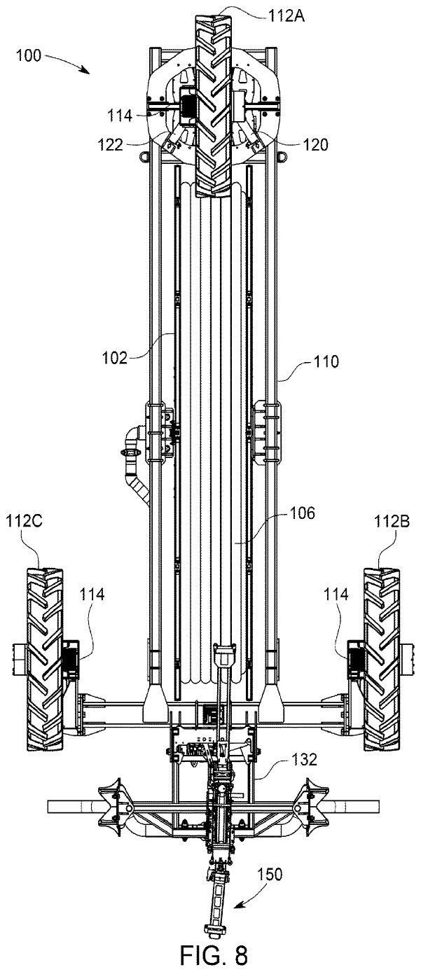

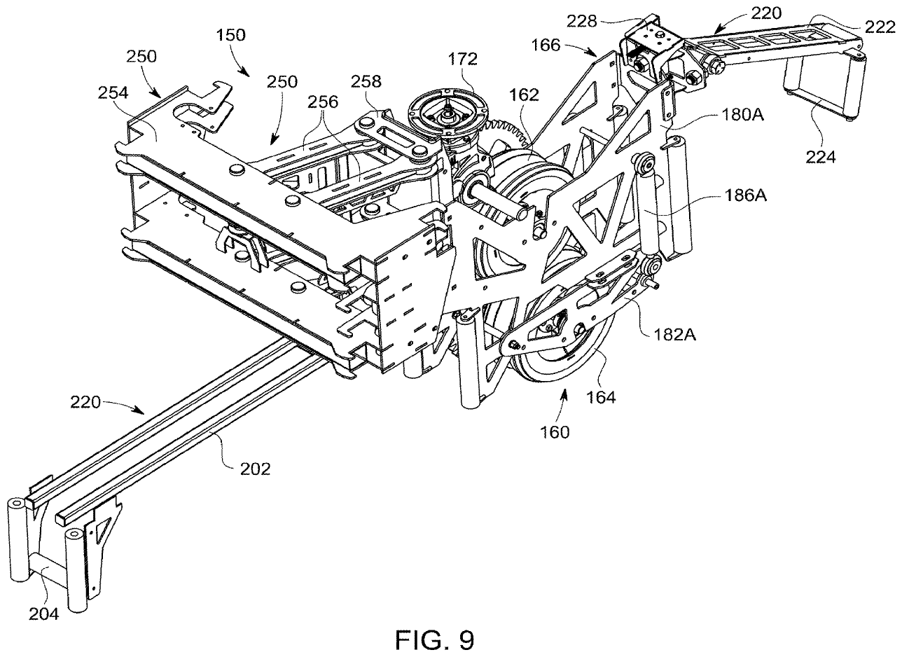

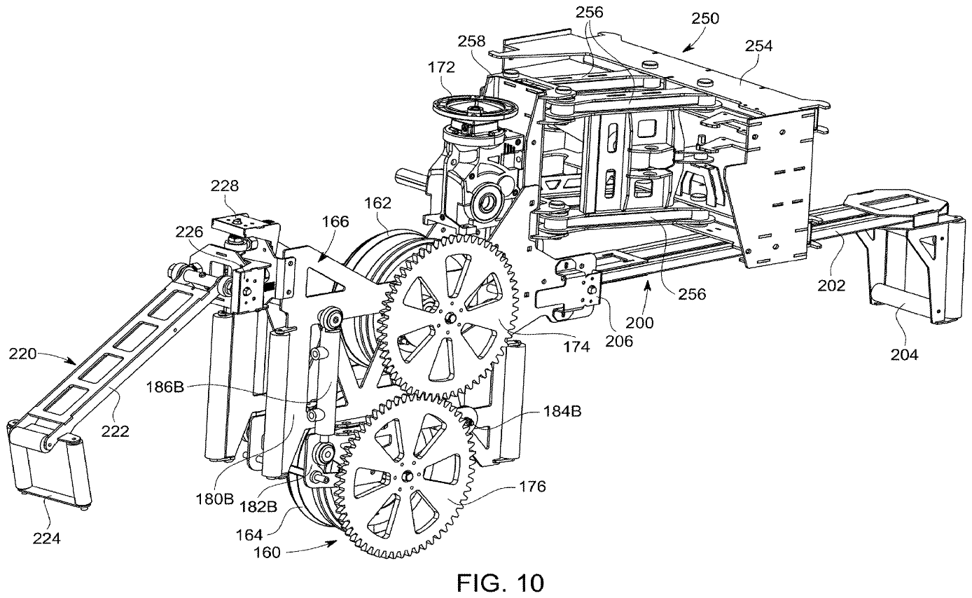

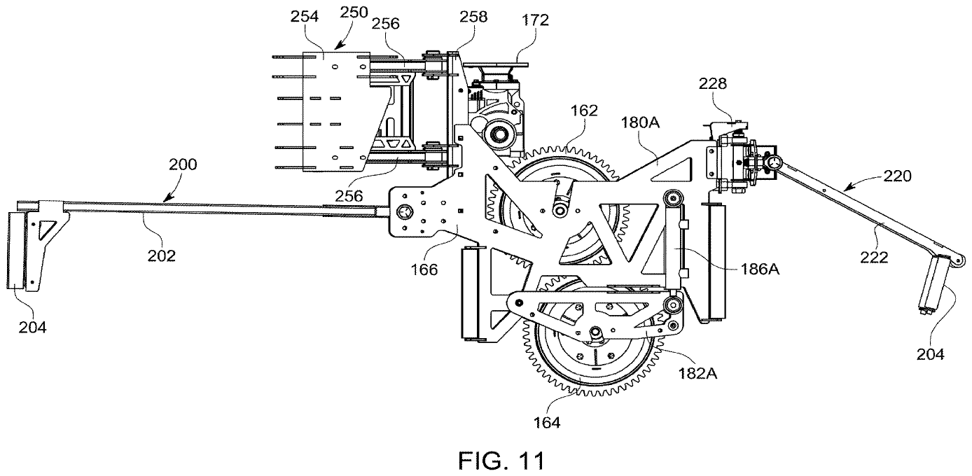

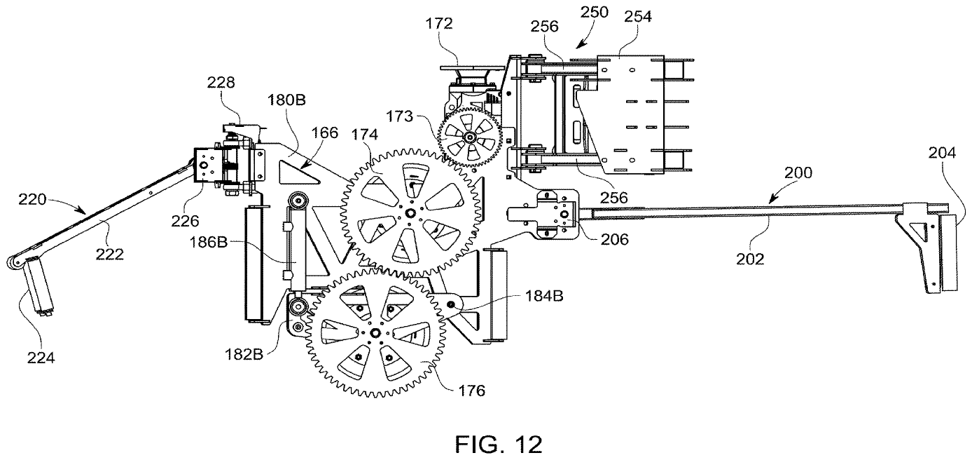

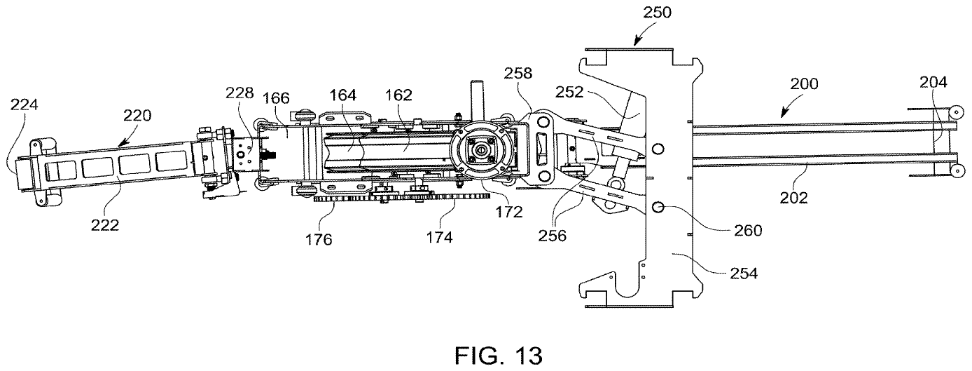

It will be appreciated that different embodiments employing one or more features of crop input applicator vehicles are described herein. Features discussed with respect to one embodiment can be applied to other embodiments as desired. Referring now to the drawing figures wherein like reference numerals designate the same or corresponding components throughout the several figures, FIGS. 1-16 illustrate one embodiment of a crop input application vehicle 100 including a reel 102 rotationally supported on a central shaft that is connected with a motor 104. In one embodiment, the central shaft is connected with the motor 104 through a planetary gear. The reel 102 supports a flexible conduit 106. The vehicle 100 includes a frame 110 supported on a plurality of wheel assemblies 112, including a front wheel assembly 112A and rear wheel assemblies 112B and 112C. Front wheel assembly 112A is steerable with respect to the frame 110 to navigate the vehicle 100 through a field of crops (e.g., a row crop). Wheel assemblies 112, in one embodiment, are powered by electric motors 114 that enable vehicle 100 to propel throughout the field. In some embodiments, an actuator assembly 118 is configured to steer the wheel assembly 112, e.g., to pivot a wheel portion relative to the frame 110. In the illustrated embodiment, actuator assembly 118 includes opposed hydraulic actuators 120 and 122.

Extending from a rearward portion of the frame 110 is a boom 130 mounted on a linkage 132 supported by the frame 110. According to various embodiments, the boom 130 can be of any number of different lengths and of any number of different configurations. For example, common boom 130 lengths include 40 feet, 60 feet, 80 feet, and 120 feet. Any other boom 130 length could be employed, as well, in accordance with different embodiments. In different embodiments, the boom 130 can be attached in front of frame 110 or behind the frame 110.

The boom 130 supports a conduit 134 extending generally transversely across the vehicle 100 and further can support a plurality of applicators. In one embodiment, the applicators include drop assemblies fluidly coupled with the conduit 134. A pump and valve assembly 136 (e.g., including an electric motor and valves) control the flow rate of fluid (e.g., crop input) to one or more selected applicators. A conduit 138 is positioned to carry fluid from conduit 106 to the conduit 134.

A power unit 146 and master control assembly 148 can be carried by frame 110 to provide power to one or more power-consuming devices (e.g., motors, pumps, processors) of vehicle 100. In one embodiment, the power unit 146 includes a diesel generator and one or more batteries to store and/or deliver power to devices on the vehicle. In other embodiments, the power unit is another power source such as a battery pack or remote power source connected with vehicle 100. Master control assembly 148 is connected to various components on vehicle 100 to provide control of the vehicle (e.g., application of liquid through drop assemblies, navigation of vehicle 100, a level of current to reel motor 104) and/or to perform one or more steps in a method of operating vehicle or components therof.

Vehicle 100 further includes a conduit control assembly 150 that controls dispensing and retraction of flexible conduit 106 relative to the ground. In one embodiment, the conduit control assembly 150 is connected to frame 110 through a bracket 152. In the illustrated embodiment, conduit control assembly 150 is positioned at a rear of vehicle 100. In other embodiments, the conduit control assembly 150 can be positioned at a front or in an intermediate position of the vehicle 100. During operation, motor 104 cooperates with conduit control assembly 150 to dispense and retract conduit 106 from and to the reel 102. Conduit control assembly 150, as discussed herein, can include one or more sensors to calculate a position of the conduit 106. In one embodiment, these sensors include angle sensors such as PST-360G2 available from Amphenol Corporation of Wallingford, Connecticut. Angle sensors can utilize a Hall effect sensor to identify a position of a shaft relative to an opening.

Conduit control assembly 150 includes a gripping assembly 160 to frictionally engage conduit 106. In the illustrated embodiment, gripping assembly 160 includes first and second gripping devices 162 and 164. In an alternative embodiment, gripping assembly 160 includes a single gripping device that frictionally engages the conduit 106. The gripping devices 162 and 164 herein are rollers, but can be other devices such as tires, tracks or other gripping devices. A frame 166 rotationally supports the gripping devices 162 and 164. In one embodiment, one or more of the gripping devices 162 and 164 can be driven by a motor 170 or other actuator. In the illustrated embodiment, motor 170 is connected to a gearbox 172, which in turn is connected through a spur gear 173 to a spur gear 174 connected to the frame 166 and rotationally connected with gripping device 162. Spur gear 174 is directly connected with spur gear 176, which is rotationally connected with gripping device 164. Gripping device 162 and gripping device 164 rotate in opposite directions upon operation of motor 170. The gripping devices 162 and 164 can be turned at a speed such that the conduit 106 is dispensed off or returned onto the reel 102 at a speed equal and opposite to the ground speed of the vehicle 100.

A distance between the gripping devices 162 and 164 can be a fixed distance or adjustable by an actuator or other mechanism (e.g., a spring) to maintain a gripping force by the gripping devices 162 and 164 onto the conduit 106. In the illustrated embodiment, frame 166 includes upper plates 180A and 180B connected to either side of gripping device 162. Additionally, frame 166 includes lower plates 182A and 182B connected to either side of the gripping device 164. Lower plate 182A is pivotally connected to upper plate 180A about a connection 184A. Additionally, a hydraulic cylinder 186A connects the lower plate 182A and upper plate 180A. As lower plate 182A pivots about connection 184A, cylinder 186A operates to maintain gripping pressure between griping devices 162 and 164. Similarly, lower plate 182B is pivotally connected to upper plate 180B about a connection 184B. Additionally, a hydraulic cylinder 186B connects the lower plate 182B and upper plate 180B. As lower plate 182B pivots about connection 184B, cylinder 186B operates to maintain gripping pressure between griping devices 162 and 164. In a further embodiment, hydraulic cylinders 186A and 186B can be operated to master control assembly 148 to adjust the position of plates 182A and 182B relative to upper plates 180A and 180B, respectively, thereby adjusting a gripping pressure between gripping devices 162 and 164.

A conduit tension sensing assembly 200 can be positioned between the frame 166 and the reel 102 to measure tension of the conduit 106 as the conduit 106 leaves or returns to the reel 102. Conduit tension sensing assembly 200 includes an elongate member 202 connected with the frame 166 and a support member 204 to support the conduit 106. A sensor 206 measures an angle of the elongate member 202 with respect to the frame 166 to calculate a tension of the conduit 106.

Gripping devices 162 and 164, in one embodiment, can be positioned to bias the conduit 106 higher or lower as the conduit 106 passes through frame 166. In one embodiment, gripping device 162 is positioned more forward relative to gripping device 164. This arrangement will bias any slack in the conduit 106 to be forced into the support member 204 to assist in obtaining a tension measurement. In one embodiment, output from sensor 206 is calculated with respect to a target set point. The target set point can be established based on a wrap layer (e.g., a position of the conduit along a width of the reel) of the conduit 106. If sensor 206 is outside of a range of the target set point, reel speed can be adjusted.

A conduit angle sensing assembly 220 can be positioned between the frame 166 and ground to measure angles of the conduit 106 as the conduit 106 leaves and returns to the reel 102. Conduit angle sensing assembly 220 includes an elongate member 222 and a support member 224. Conduit 106 is positioned within the support member 224. A vertical angle sensor 226 measures an angle of elongate member 222 about an axis parallel to the ground. Additionally, a horizontal angle sensor 228 measures an angle of elongate member 222 about an axis perpendicular to the ground.

Vertical conduit angle sensor 226 detects changes in the shape of the conduit as it leaves the frame 166. If too much conduit is being dispensed relative to the ground speed of the vehicle, the conduit will tend to rise higher off the ground and lift the elongate member 222. The speed of the gripping devices 162 and 164 can then be lowered to reduce the amount of conduit dispensed and allow the vertical angle sensor 226 to return to a selected target position. Likewise, if too little conduit is being dispensed relative to the ground speed of the vehicle, the conduit will drop towards the ground and pull the elongate member 222 down. The speed of the gripping devices 162 and 164 can then be increased to speed up the amount of conduit being dispensed such that the vertical angle sensor 226 returns to the selected target position.

During operation, a speed (i.e., displacement per unit of time) of the gripping devices 162 and 164 can be adjusted based on measurement from horizontal angle sensor 228 to account for errors that would result in an incorrect length of conduit leaving or returning to the reel 102. In one embodiment, the speed of the conduit passing through the frame 166 is adjusted to keep the horizontal angle sensor 228 positioned straight relative to the frame 166. In another embodiment, the speed of the conduit is adjusted to align the horizontal angle sensor 228 with a direction of travel of the vehicle 100 as it moves. In one example as the vehicle turns through a curve, too little conduit may be dispensed. The horizontal angle sensor 228 will be pulled towards the inside of the curve by the conduit. The speed of the gripping devices 162 and 164 can then be increased to dispense more conduit and thereby push the horizontal angle sensor 228 back to a selected target position. Likewise, if too much conduit is being dispensed, the conduit will push the horizontal angle sensor 228 away from the inside of the curve. The speed of the gripping devices 162 and 164 can then be reduced to dispense less conduit and allow the horizontal angle sensor to return to the selected target position.

The conduit control assembly 150 can further be mounted to a traverser 250 positioned to move the conduit 106 side to side (i.e., laterally) relative to the reel 102 as it passes through the frame 166. As conduit 106 is retracted onto the reel 102, the traverser 250 is moved by an actuator 252 (herein illustrated as a linear hydraulic cylinder) to position the conduit 106 next to the previous wrap created on the reel 102. Traverser 250 includes a bracket 254 that is directly coupled with bracket 152. Connected with the bracket 254 are linkage arms 256 coupled with the actuator 252. Linkage arms 256 are further connected to a vertical bracket 258 that is directly coupled with frame 166. Linkage arms 256 are connected to pivot with respect to the bracket 254 and the vertical bracket 258 such that actuator can pivot linkage arms 256, which in turn positions frame 166. This arrangement allows conduit 106 to be efficiently stored on the reel 102 in sequential wraps. A traverser sensor 260 may be used to monitor the position of the traverser. As conduit is removed from the reel 102, the traverser 250 can be positioned to align with the wrap being unwound at that time, or be positioned in a center of the reel 102 and allow the conduit 106 to flex from where the conduit 106 was wrapped on the reel 102 to pass through the frame 166.

Features of conduit control assembly 150 can be changed in various other embodiments. For example, a linear actuator can be used in place of gripping devices 162 and 164. In this embodiment, two or more gripping arms can be mounted on the end of the linear actuator and positioned to selectively grip the conduit 106. In order to dispense conduit 106, the linear actuator retracts with the gripping arms spread apart. The gripping arms are then closed on the conduit 106 and the linear actuator pushed forward to dispense conduit 106 at a speed equal and opposite of the direction of travel of the vehicle. Sensors described herein may also be used to adjust the speed of the reel 102 or linear actuator to ensure the correct amount of conduit 106 is dispensed from or returned to the vehicle 100.

In other embodiments, the conduit control assembly 150 can be mounted at the front of the vehicle 100 and dispense conduit from the reel 102 such that it tends to intersect the ground beneath the vehicle 100. In this embodiment, conduit tension sensing assembly 200, or other forms of sensors such as an angle sensor, ultrasonic sensor, camera or other contact or non-contact sensor capable of measuring conduit tension may be positioned between the frame 166 and the reel 102 and the reel speed may be adjusted to maintain the conduit tension sensing assembly 200 at a target tension.

In a further embodiment, conduit control assembly 150 can include a ground intersection sensor such as a contact arm with an angle sensor, a camera, ultrasonic, radar, or other contact or non-contact sensor positioned to measure a location where the conduit 106 first contacts or leaves the ground as the vehicle 100 dispenses or retracts conduit. The speed of the gripping devices 162 and 164 can be adjusted to maintain the consistent position where the conduit 106 first contacts or leaves the ground ensuring the correct amount of conduit is dispensed or retracted relative to the speed of the vehicle. One or more additional ground intersection sensors may be used along the remaining length of the vehicle 100 to confirm that the conduit 106 remains in the correct position on the ground.

In another embodiment a control arm extended from the conduit control assembly 150 and force is applied through the arm with a linear, rotary, or other actuator to push the conduit down on the ground so that a reliable first intersection position may be determined by an angle sensor positioned on the arm. Alternatively, or in addition, conduit guides may also be mounted along a length of the vehicle to limit the freedom of the conduit to move on the ground while the vehicle passes over it.

In another embodiment, two control arms can extended from the conduit control assembly 150. A first control arm can apply force to the conduit 106 through an actuator to ensure a measurement by a sensor where the conduit 106 is in contact with the ground and the position of the ground relative to the vehicle. A second control arm can be mounted between the first control arm and the frame 166 to determine the path the conduit takes between the frame 166 and the first control arm by measuring its position with a sensor. The speed of gripping devices 162 and 164 can be adjusted so that the conduit 106 follows a desired path between the frame 166 and the ground ensuring that the amount of conduit dispensed or returned to the vehicle is correct.

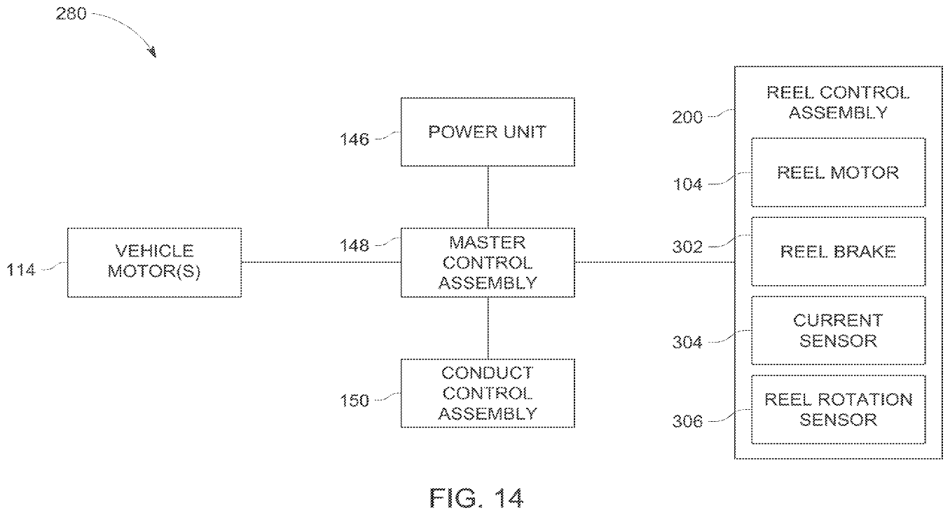

In addition to control of conduit 106 through conduit control assembly 150, vehicle 100 can be configured to control reel 102. FIG. 14 is a schematic diagram of a control system 280 used to control components of vehicle 100. As illustrated, during operation of vehicle 100, master control assembly 148 receives power from power unit 146 to operate and/or receive information from, among other components vehicle motors 114, conduit control assembly 150 and a reel control assembly 300. Reel control assembly 300 includes reel motor 104, a reel brake 302, a current sensor 304 and a reel rotation sensor 306.

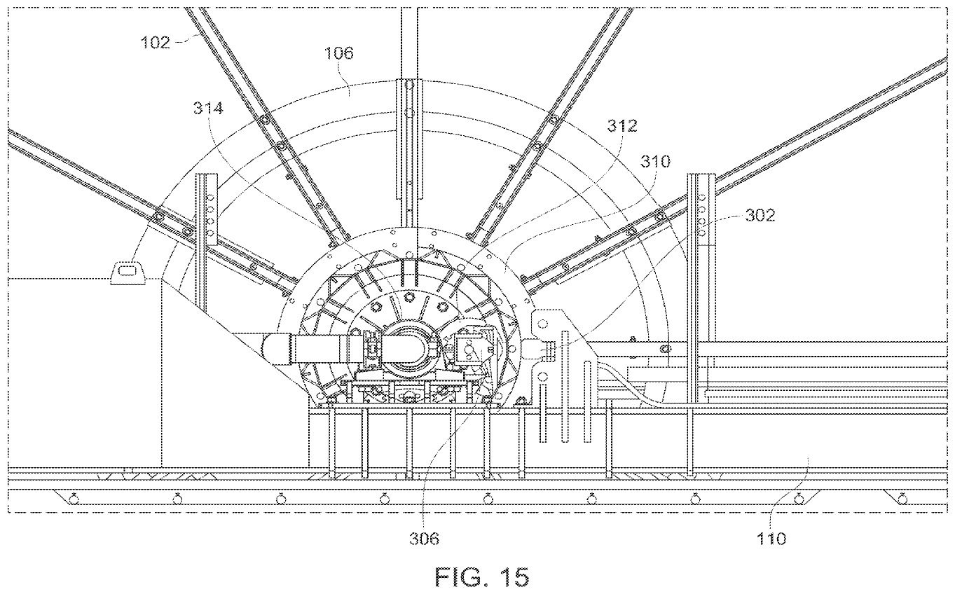

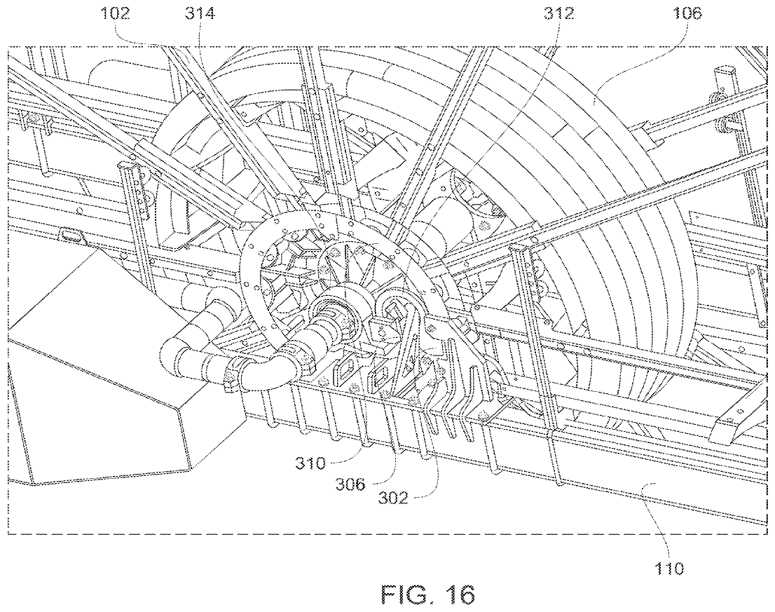

With additional reference to FIGS. 15 and 16, reel 102 is shown with a single layer of conduit 106 positioned thereon and mounted to frame 110. In some instances, tension of the conduit 106 wrapped on the reel 102 may cause the reel 102 to move when the reel 102 is not being controlled by reel motor 104. As such, reel brake 302 (e.g., a hydraulic actuated compression brake) may be used to prevent rotation of the reel 102 with respect to the frame 110 when the reel 102 is not being operated. Additionally, a brake ring 310 is mounted to the reel 102 and positioned to pass through compression pads (i.e., facing the brake ring 310) of the reel brake 302. Master control assembly 148 is configured to control reel brake 302, which is responsive to apply braking pressure to reel 102.

Reel rotation sensor 306 can be mounted to a sensing gear 312 positioned to engage a reel gear 314 mounted to a center of the reel 102. As the reel 102 turns, the reel gear 314 rotates sensing gear 312, which in turn rotates reel rotation sensor 306. Gears 312 and 314 may be sized identically so the rotational relationship is 1:1 or gears 312 and 314 may have different sizes and the rotational relationship calculated by master control assembly 148 to determine rotation of reel 102.

Conduit 106 is stored on the reel 102 as two or more wraps forming a layer with a similar radius. For example, FIG. 16 illustrates six wraps of conduit 106 about the reel 102 to form a single layer. As an amount of conduit 106 stored on the reel 102 changes, a weight of the conduit 106 on reel 102 changes, resulting in more or less torque required by motor 104 to drive reel 102. Master control assembly 148 can adjust a level of current applied to motor 104 based on the amount of conduit 106 stored on reel 102.

One approach to calculating the amount of conduit 106 stored on reel 102 is based on an “effective radius” of the reel 102, which can be defined as a distance measured from a central rotational axis of the reel 102 to an outer most and upper most position of conduit 106 positioned on the reel 102. Based on a calculation of the effective radius (which is indicative of an amount of conduit positioned on reel 102), a target speed of the reel 102 can be determined to match the ground speed of the vehicle 100 (e.g., which can be calculated based on operation of motors 114). In one embodiment, master control assembly 148 compares the distance traveled by the vehicle 100 during a full rotation of the reel 102 as measured by the reel rotation sensor 306 and calculates the effective radius of the reel 102 that corresponds to the distance traveled. Master control assembly 148 may then average the radius calculated when each wrap of a layer is added or removed to improve accuracy of the calculation of effective radius for that layer.

The calculated effective radius may further be used to determine a position target for conduit 106 as conduit 106 is dispensed from or retracted onto reel 102, which can be referred to as a dispensing position of the conduit 106. In one embodiment, the dispensing position is a location of one or more components of conduit control assembly 150 in relation to vehicle 100. For example, the dispensing position can be the location of support member 204 and/or 224 in relation to frame 110. The dispensing position can be calculated by one or more of sensors 206, 226 and 228 while adding or removing wraps of a particular layer of conduit 106 onto or from reel 102. In one example, a linear relationship between the target position and effective radius is used to establish the target position. A formula y=mx+b can be applied, where y is the position target of the dispensing position sensed by sensors 206 and/or 226 and x is the effective reel radius. A regression analysis can be used to estimate and adjust a slope m and intercept b to generate a desired position target for sensors 206 and/or 226 for different values of the effective reel radius x. Alternatively, a non-linear relationship may be used to calculate the position target.

The position target may be further calculated by measuring and controlling the torque being applied to the reel 102 during operation. In one embodiment, the reel 102 is driven by electric motor 104 and a level of current provided by master control assembly 148 (and thus drawn by the electric motor 104) is measured by current sensor 304. The position target is adjusted up or down from a selected position target generated from the effective reel radius as discussed above so that the actual current drawn by electric motor 104 driving the reel 102 meets a desired current target. Multiple current targets may be used depending on various circumstances, such as when dispensing conduit 106 from reel 102 versus retracting conduit 106 onto reel 102. The current targets may be a fixed value or generated as a linear relationship to a measured rotation speed of the reel 102. In each case, the current target should be set so that the tension in the conduit 106 is sufficient to maintain tight wraps on the reel 102 during operation. Alternatively, no original position target is used and the position target is exclusively generated so that the level of current applied to motor 104 matches the current target. In a further alternative, no conduit tension sensor is used and the tension in the conduit is controlled by changing the speed of reel 102 so that the current provided to the motor 104 matches the current target.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A control system for a crop input application vehicle having a reel and a conduit positioned on the reel, comprising:
a motor configured to drive rotation of the reel;
a current sensor configured to measure current drawn by the motor to drive rotation of the reel; and
a control assembly configured to adjust a level of current delivered to the motor based on the measured current.

2. The control system of claim 1, further comprising a rotation sensor coupled with the reel and configured to determine a rotational position of the reel.

3. The control system of claim 2, wherein the control assembly provides an output indicative of an amount of conduit positioned on the reel based on the determined rotational position of the reel.

4. The control system of claim 3, wherein the control assembly is configured to adjust the level of current delivered to the motor based on the amount of conduit positioned on the reel.

5. The control system of claim 1, further comprising a brake coupled with the reel and responsive to apply braking pressure to the reel.

6. The control system of claim 1, further comprising a conduit tension sensor coupled with the conduit and configured to provide an output indicative of a dispensing position of the conduit relative to the vehicle, wherein the control assembly is configured to adjust the level of current based on the dispensing position of the conduit.

7. A method of controlling a reel of a crop input application vehicle, wherein a conduit is configured to extend from or retract onto said reel, the method comprising:
driving rotation of the reel using an electric motor; and
adjusting a current level provided to the electric motor in driving rotation of the reel based on an amount of conduit positioned on the reel.

8. The method of claim 7, further comprising applying a brake to the reel to prevent rotation of the reel.

9. The method of claim 7, further comprising measuring rotation of the reel and calculating the amount of conduit positioned on the reel based on the measured rotation.

10. The method of claim 7, further comprising determining a dispensing position of the conduit relative to the vehicle.

11. The method of claim 10, further comprising:
calculating a target position of the conduit;
comparing the target position to the dispensing position; and
adjusting the current level provided to the electric motor based on comparing the target position and the dispensing position.

12. A crop input application vehicle, comprising:
a vehicle frame supported by a plurality of wheel assemblies;
a reel having a conduit positioned on the reel and supported by the vehicle frame;
a power unit coupled to the frame; and
a control system, comprising:
a motor configured to drive rotation of the reel;
a current sensor configured to measure current drawn by the motor to drive rotation of the reel; and
a control assembly configured to adjust a level of current delivered to the motor based on the measured current.

13. The vehicle of claim 12, further comprising a rotation sensor coupled with the reel and configured to determine a rotational position of the reel relative to the frame.

14. The vehicle of claim 13, wherein the control assembly provides an output indicative of an amount of conduit positioned on the reel based on the determined rotational position of the reel.

15. The vehicle of claim 14, wherein the control assembly is configured to adjust the level of current delivered to the motor based on the amount of conduit positioned on the reel.

16. The vehicle of claim 12, further comprising a brake coupled with the reel and responsive to apply braking pressure to the reel.

17. The vehicle of claim 12, further comprising a conduit tension sensor coupled with the conduit and configured to provide an output indicative of a dispensing position of the conduit relative to the frame, wherein the control assembly is configured to adjust the level of current based on the dispensing position of the conduit.
